(19) United States
(12) Patent Application Publication
(10) Pub. No.: US 2012/0235427 A1
(43) Pub. Date: Sep. 20, 2012

(54) SECURITY DEVICE FOR A DOUBLE DOOR

(75) Inventors: Hugh Michael Miskel, Marietta, GA (US); John Tyler Willis Hagler, Durham, NC (US); Patrick Brian Murphy, Cary, NC (US)

(73) Assignee: MOUNTAIN VIEW PROMOTIONS, INC., Marietta, GA (US)

(21) Appl. No.: 13/421,580

(22) Filed: Mar. 15, 2012

Related U.S. Application Data
(60) Provisional application No. 61/452,659, filed on Mar. 15, 2011.

(51) Int. Cl. E05C 19/18; B23P 11/00; E05C 19/10

(52) U.S. Cl. 292/288; 29/428

(57) ABSTRACT

A security device for a double door, including a first locking portion having a curved portion and an elongated male portion, and a second locking portion having a curved portion and an elongated female portion. A lock mechanism includes a pair of rows of teeth having a gap therebetween and associated with the bottom side of the male portion and a locking prong mounted to the female portion. The locking prong has a flexible finger portion that terminates in a T-shaped end. The finger portion can slide between the gap in the rows of teeth. A release button mounted on the female portion, when pressed, causes the locking prong to bend downward, disengaging the T-shaped end from between the teeth and allowing the first and second locking portions to separate, thereby unlocking the security device.

### CROSS-REFERENCE TO RELATED APPLICATION

This application claims benefit of copending U.S. provisional patent application No. 61/452,659, filed Mar. 15, 2011, entitled Double Door Guard Protection Device, and commonly assigned to the assignee of the present application, the disclosure of which is incorporated by reference in its entirety herein.

### FIELD

The present disclosure relates to door security devices and locks, and, more particularly to a security device for a double “French” door.

### BACKGROUND

Typical residential swinging (as compared to sliding) doors are either a single door or a double door, the latter often being known as a “French” door. A single door is the more secure of the two types of traditional doors, but single doors are still vulnerable based on the weak door frame construction.

A double door typically has a first door that can be unlockably secured to the door frame with pins in the top and bottom of the door that enter the door frame. A second door is locked in place by a traditional door lock and/or a deadbolt that interacts with a striker plate in the first door. The second door is difficult to secure because there is no door jam to aid in reinforcement.

It would be desirable to have a security device for a double door that can withstand substantial force (e.g., forced entry level force), yet be easily attached or removed. Such a door security device would be conveniently storable. It would also provide a shape that is aesthetically pleasing and that would not be overly prominent in presence.

### SUMMARY

Generally described, the present disclosure provides in a first exemplary embodiment a security device for a double door, the door having a first door and a second door, each door having a set of hinges and a door handle or knob, the security device comprising, a first locking member having a first side having at least one first attachment post, a second side having at least one attachment aperture, at least one fastener that can pass through an attachment aperture and secure to an attachment post, a first curved portion formed by a portion of the first and second sides, an elongated male portion having a top side and a bottom side, the bottom side having a first row of teeth and a second row of teeth associated therewith, there being a gap between the first and second rows of teeth forming a channel therethrough; a second locking member connectable to the first locking member and having a first side having at least one first attachment post, second side having at least one attachment aperture, at least one fastener that can pass through an attachment aperture and secure to an attachment post, a second curved portion formed by a portion of the second locking member first and second sides, an elongated female portion having a top side containing a slotted aperture and a channel sized to accommodate the first locking member elongated male portion; a button adapted to slide within the second locking member elongated female portion slotted aperture, the button having a top first portion and an elongated post extending downward therefrom, the post terminating in a connector portion; and, a locking prong having a base portion adapted to be connected to the second locking member and further having a finger portion including an elongated slot and a T-shaped distal end, whereby the finger portion elongated slot is sized to accept the connector portion of the post, wherein the first locking member male portion is adapted to be received and slide within the second locking member female portion such that when the security device is in a locked configuration the locking prong can slidingly fit within the gap between the first and second rows of teeth in the elongated male portion and such that the distal end of the locking prong can fit between two adjacent teeth in neighboring rows of teeth, thereby preventing movement of the first and second locking members with respect to each other, and, when the security device is in an unlocked configuration achieved by pressing the button which causes the locking prong finger portion to flex downward and the distal end disengages from between the rows of teeth to permit sliding relative movement of the first and second locking members, thereby permitting disengagement of the security device from either or both door handles.

Another aspect of the present disclosure provides an apparatus for controllably preventing or permitting access to a room or chamber, comprising: a first door and a second door, each having a door handle, knob or pocket, as described hereinabove, and a security device as described herein.

Another aspect of the present disclosure provides a method of securing a double door having a first and a second door, each door having a door handle or pocket, comprising: providing a security device as described herein; closing the first and second doors; pressing the release button to expand the security device; mounting the security device on the first and second doors such that the first locking portion engages the first door handle or pocket and the second locking portion engages the second door handle or pocket; pressing the release button to collapse the security device so that the first and second locking portions move toward each other; and, releasing the release button to maintain the first and second locking portions in a locked relative position.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a perspective view in partial cutaway of one exemplary embodiment of the present disclosure.

FIG. 2 is an exploded view of the exemplary embodiment of FIG. 1.

FIG. 3 is a perspective view, in partial cutaway, of the exemplary embodiment of FIG. 1.

FIG. 4 is a left side elevational view of the exemplary embodiment of FIG. 1 in an extended configuration.

FIG. 5 is a bottom plan view of the exemplary embodiment of FIG. 1 in an extended configuration.

FIG. 6 is a left side elevational cutaway view of the exemplary embodiment of FIG. 1 in an extended configuration.

FIG. 7 is a left side elevational cutaway view of the exemplary embodiment of FIG. 1 in a contracted configuration.

FIG. 8 is a right side elevational cutaway view of the exemplary embodiment of FIG. 1 in an extended configuration.

FIG. 9 is a right side elevational cutaway view of the exemplary embodiment of FIG. 1 in a contracted configuration.

FIG. 10 is a detail perspective view of a portion of an exemplary embodiment of FIG. 1 showing the bottom of the male member and female member and illustrating the engagement of the locking prong with the teeth.

FIG. 11 is a right side elevational cutaway view of a detail of the security device illustrating the flexing of the locking prong when the release button is pressed and the security device is in a extended configuration.

FIG. 12 is a right side elevational cutaway view of a detail of the security device illustrating the flexing of the locking prong when the release button is pressed and the security device is in a contracted configuration.

FIG. 13 is a perspective view of a security device according to one exemplary embodiment of the present disclosure in a extended position ready to engage a set of double door handles.

FIG. 14 is a perspective view of a security device according to one exemplary embodiment of the present disclosure in a contracted position engaging a set of double door handles.

FIG. 15 is a perspective view of a security device according to one exemplary embodiment of the present disclosure in a contracted position engaging a set of double door pockets.

FIG. 16 is a detailed perspective view of according to an alternative exemplary embodiment featuring curved teeth.

FIG. 17 is a side elevational view of an alternative exemplary embodiment of a security device in which a key lock is incorporated.

FIG. 18 is a perspective view of an alternative exemplary embodiment of a security device which can accommodate a conventional padlock.

### DETAILED DESCRIPTION

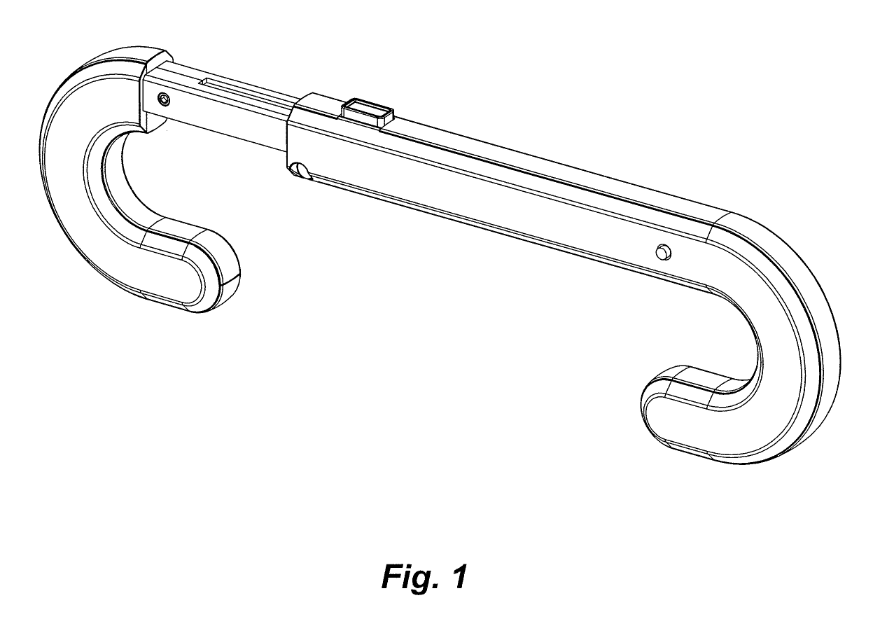

FIG. 1 shows a first exemplary embodiment of a security device of the present disclosure. The security device generally comprises a first locking member, a second locking member, a locking prong, and a prong release button.

The first locking member comprises a first generally U-shaped curved portion and an elongated male portion extending from one end of the curved portion. The male portion has a top having an elongated slot formed therein. The male portion further has a bottom that includes two opposing rows of teeth separated by a gap.

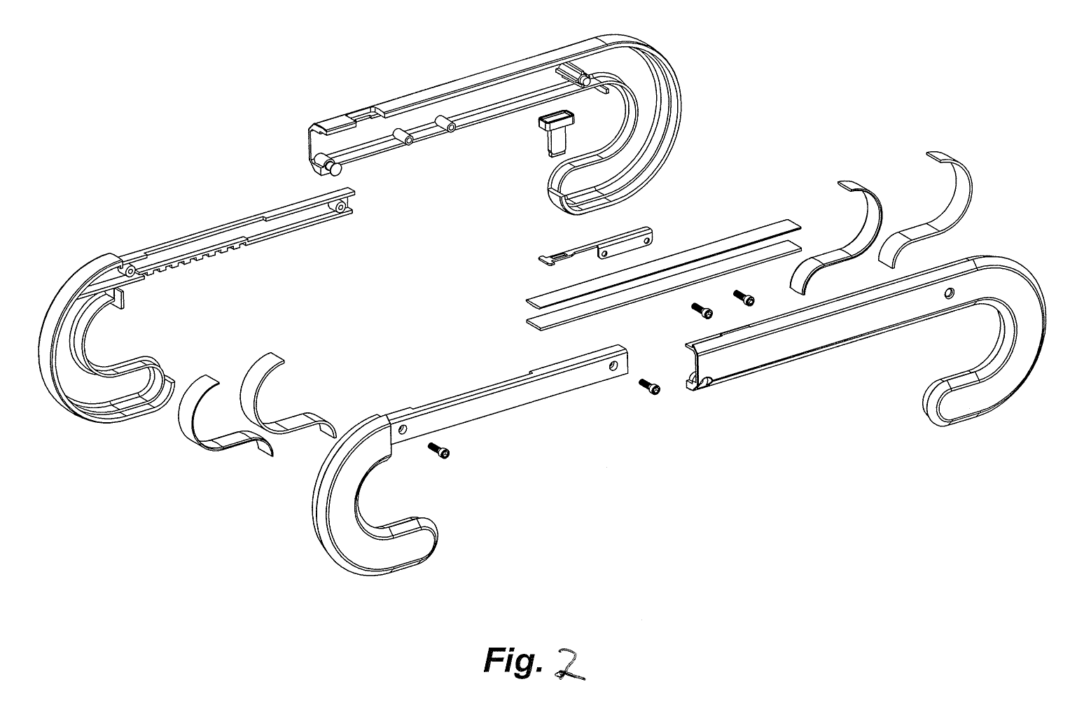

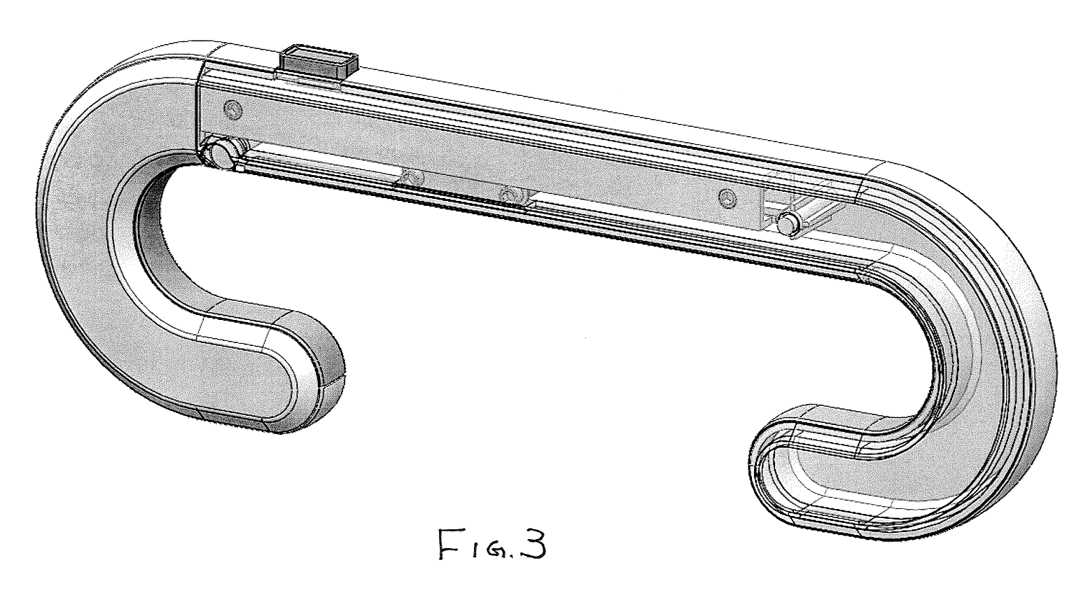

The first locking member may be made from a first piece and a second piece, as shown in FIGS. 2-3. The first piece has a bottom containing one row of teeth. The first piece has at least one, and, as shown in FIG. 2, two stems, each having a hole therein which can receive a fastener. The second piece has a bottom having a row of teeth. The second piece has a side. For each stem the side has one aperture through which the fastener can pass. The first piece and second pieces may be joined by snap-fitting or otherwise aligning the two pieces and attaching the fasteners through the holes in the side and into the stem holes. In one exemplary embodiment the fasteners are threaded and the stem holes have internal threads.

The second locking member comprises a first generally U-shaped curved portion and an elongated female portion extending from one end of the curved portion. The female portion has a top having a slot formed therein. The slot can accommodate the release button, as described in further detail herein below. The female portion further has a bottom.

The second locking member may be made from a first piece and a second piece, as shown in FIG. 2. The first and second pieces are configured to be joined together, such as by a snap fit, glue, welding, or the like. In one exemplary embodiment the first piece may have a stem terminating in a protrusion that can be force fitted into a hole in the second piece. In one exemplary embodiment the first piece may further have a second stem terminating in a protrusion that can be force fitted into a hole in the second piece. Alternatively (and not shown), the stems may each have a bore at least partially therein that can receive a fastener through a hole in the second piece. The second piece further has at least one and preferably two stems each having a hole defined therein.

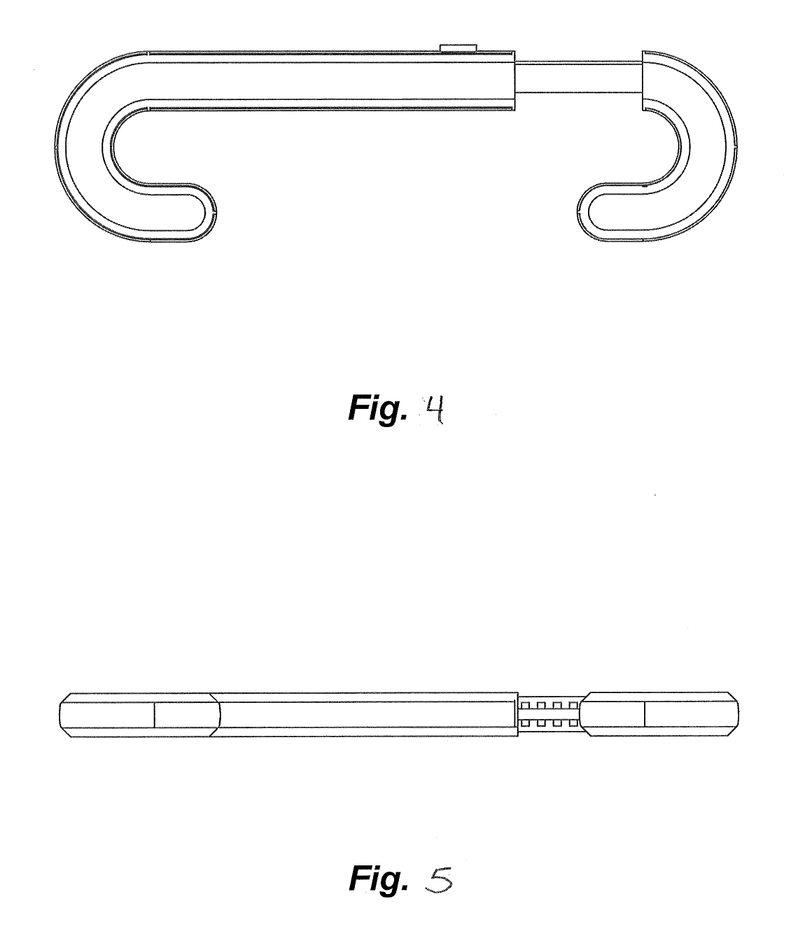

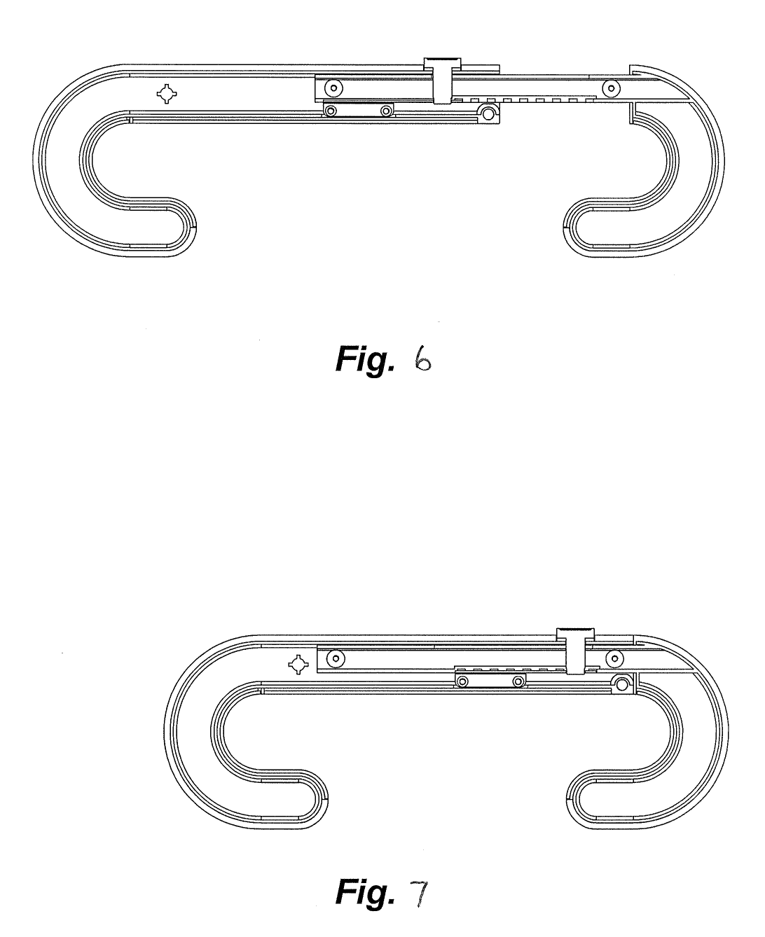

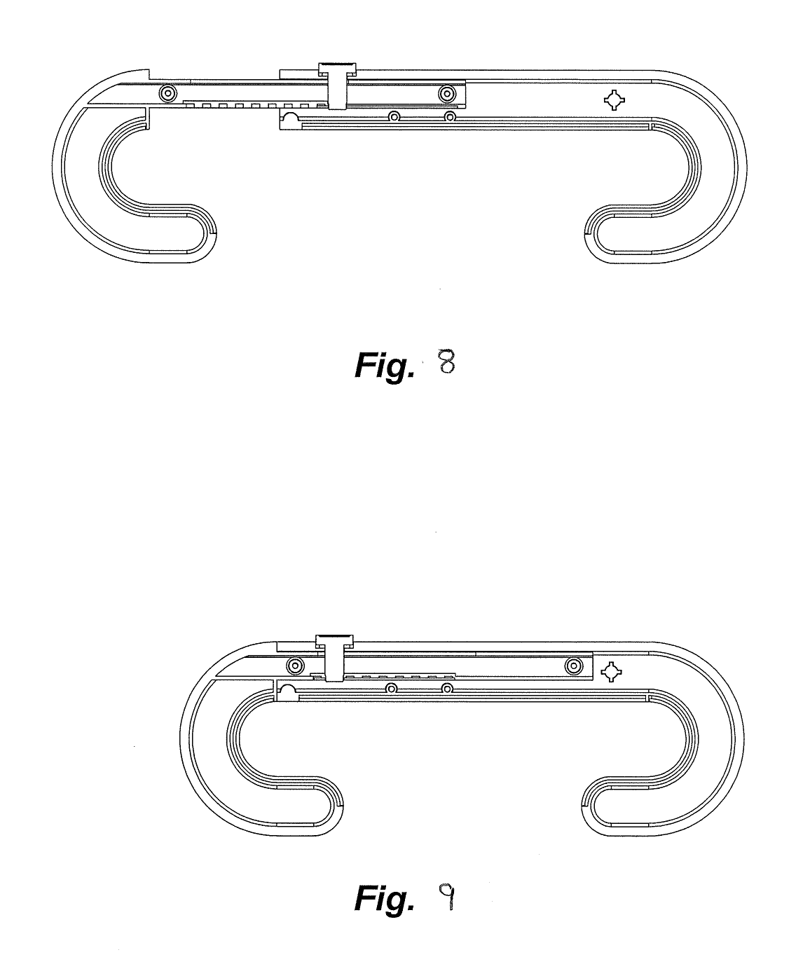

FIGS. 4-9 show various views of a security device according to one exemplary embodiment. The prong release button has a contact portion and a post portion, the post portion slidingly being received within the slot in the second locking member female portion. The post portion terminates in an end portion.

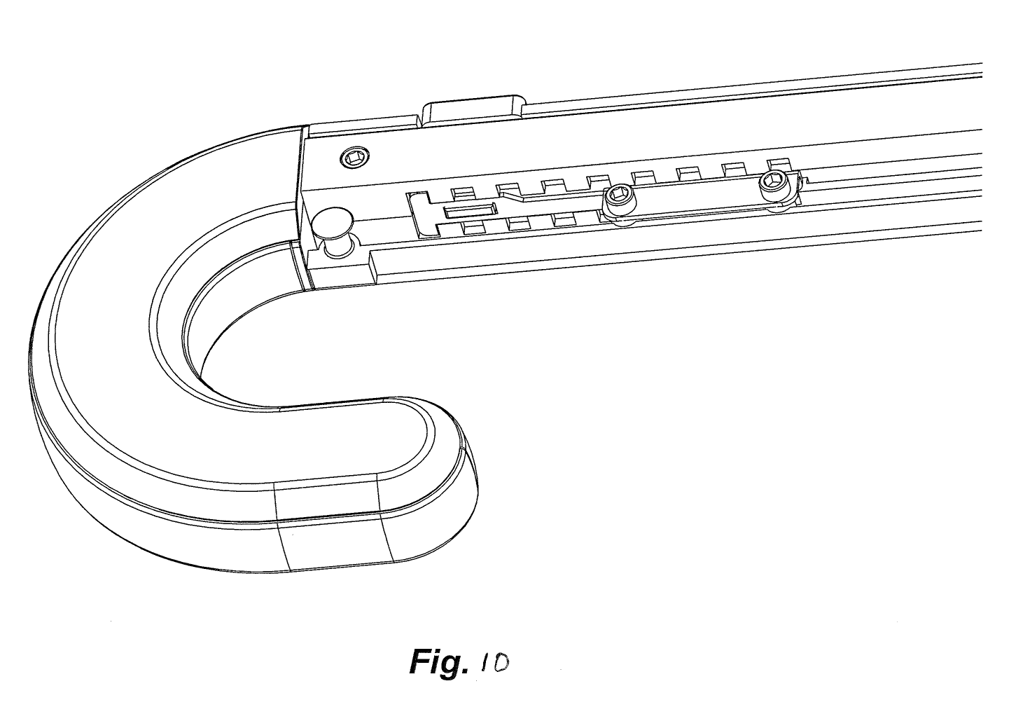

The locking prong has an attachment portion that may have a flange having at least one hole defined therein. The attachment portion can be attached to the second locking member by a fastener passing though the hole and fastening to a post. The locking prong also has a finger portion having a distal end terminating in a T-shape. The finger portion also has a slot defined therein sized to accommodate the end portion of the release button post. In one exemplary embodiment the end portion is deformed slightly and force fitted into the slot such that the end portion is retained in the slot. The finger portion has a width that is able to fit between the two rows of teeth in the first locking member male portion, as shown in FIGS. 10-12.

The first and second locking members may be made of any suitable material that is generally rigid and has requisite strength, such as, but not limited to, metal, plastic, composite, combinations of the foregoing or the like. In one exemplary embodiment, as shown in FIG. 2, a plastic insert and a rubber insert can be incorporated into the U-shaped curve of the curved portions of the first and second locking members. Similarly, a plastic insert and a rubber insert can be incorporated into the second locking member female portion. The locking prong may be made of a material having requisite strength and sufficient flexibility to bend slightly; the material may be metal, plastic, combinations thereof, or the like.

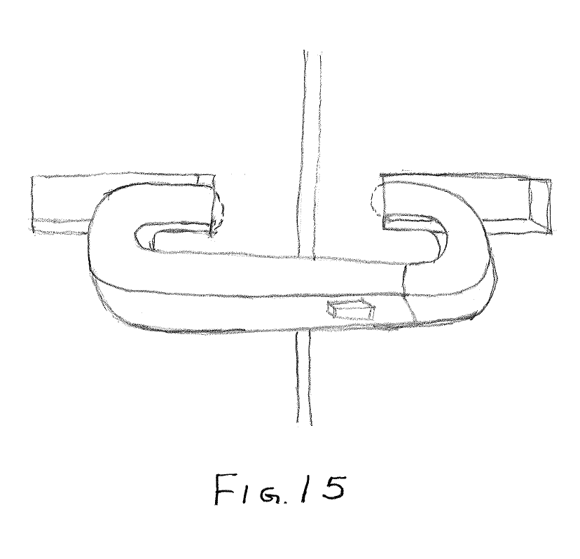

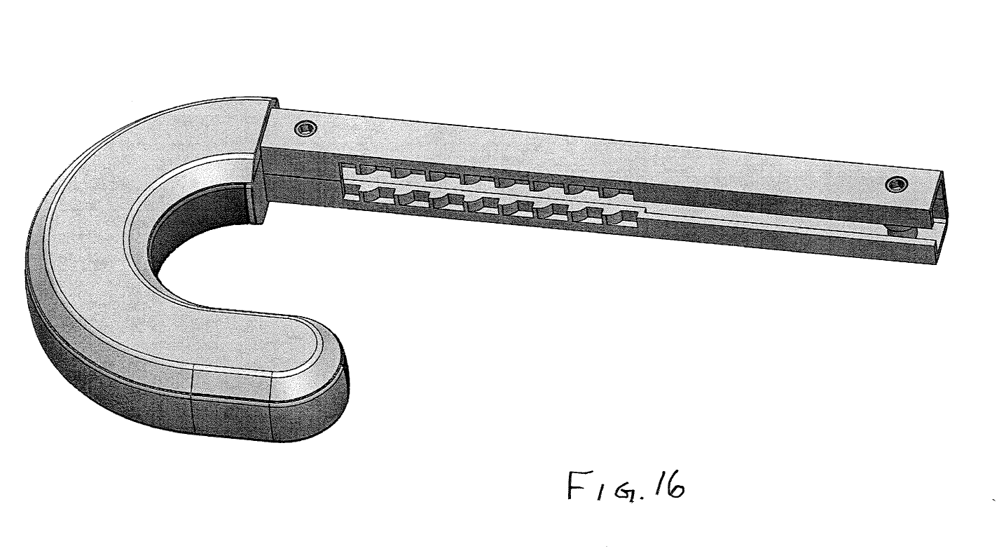

FIGS. 13-14 show various views of one exemplary embodiment of a security device of the present disclosure in use with a double door having a first door, a second door, a first doorknob and a second doorknob. It is to be understood that instead of a doorknob a handle, bar, or other protrusion from the door itself could be used. Alternatively, as shown in FIG. 15, portions of the first and second locking members of the security device of the present disclosure can be inserted within a pocket, recess or slot or hole in each of the first and second doors. The first and second curved portions can be adapted in shape to be more rectangular or hook-like to be more easily insertable into a recess in the doors.

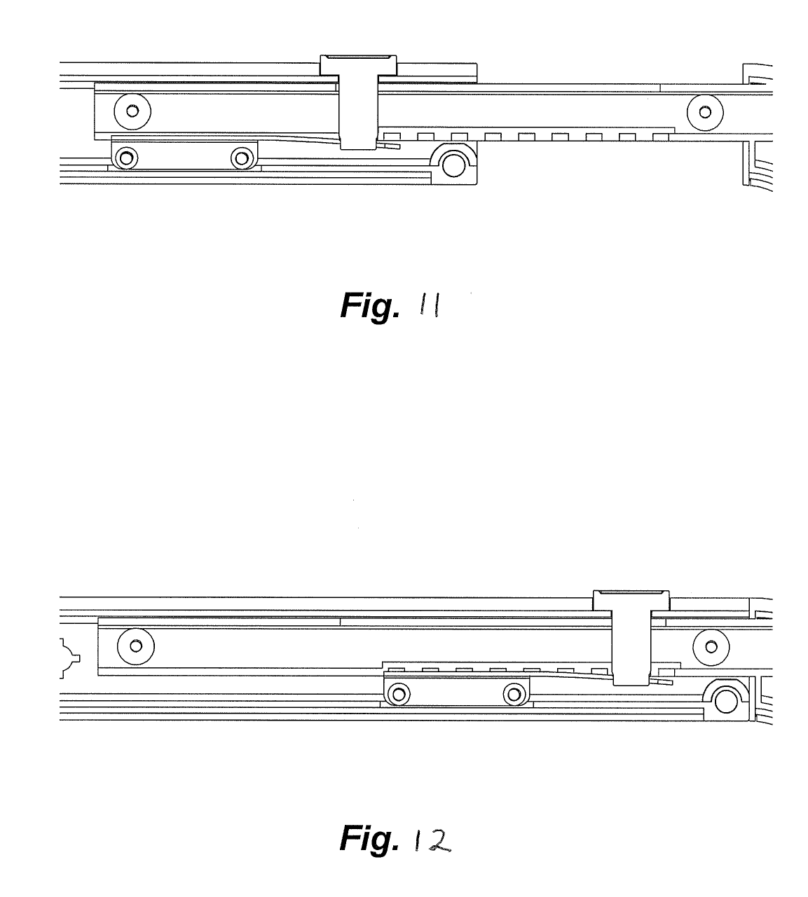

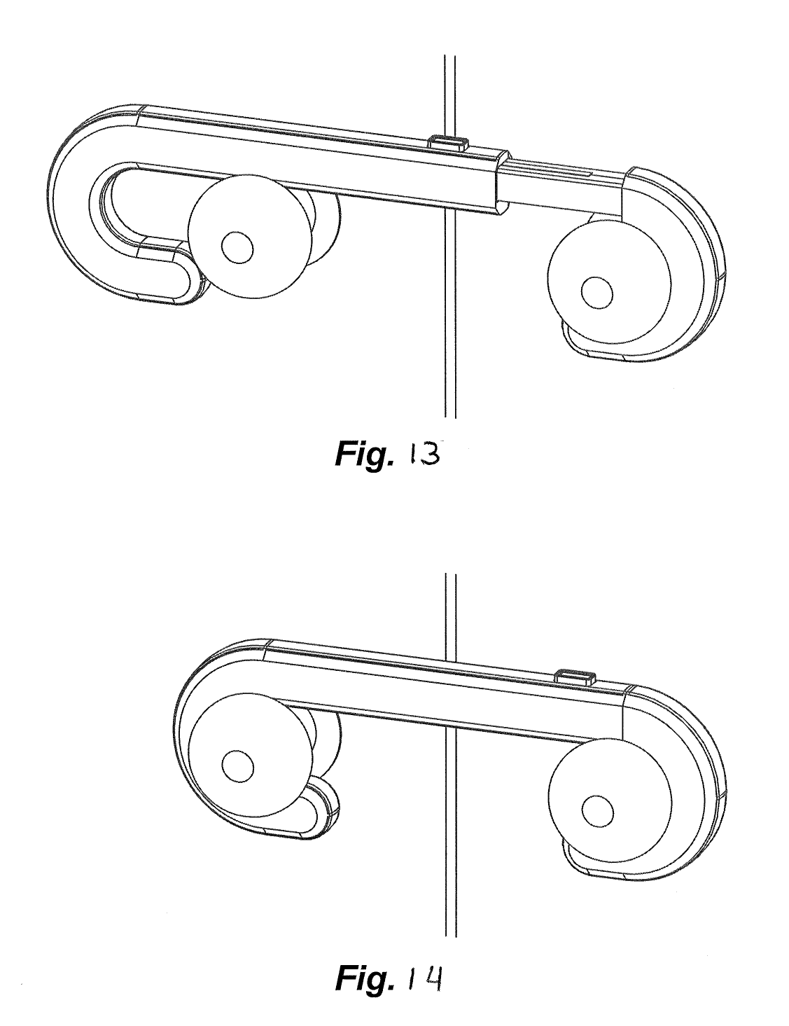

In use, the security device has an extended unlocked configuration as shown in FIGS. 4, 6, 8, 11 and 13 and a telescoped locked configuration, as shown in FIGS. 3, 7, 9, 12, and 14. The security device can be initially provided in either configuration. If provided in a telescoped locked configuration, a user can extend the security device, i.e., widen the distance between the first and second locking members, by pressing the release button. The release button post slides in the slot and urges the locking prong downward and away from the rows of teeth, thereby disengaging the T-shaped end from the gap in the rows of teeth, as shown in FIGS. 11-12. This enables the male portion to slide at least partially out of the female portion. The distal end of the slot in the male portion prevents the release button from sliding past end of the male member, thereby preventing complete removal/separation of the first and second locking members. Releasing the release button causes the locking prong to be urged upward and against the bottom of the male portion that may or may not be proximate to the rows of teeth.

With the first and second locking portions now separated, the user can hook each locking portion around one or the other of the first and second door doorknobs (assuming the doors are closed). Alternatively, the first and second curved portions can be inserted into pockets in the doors. To collapse/telescope the first and second locking portions the user presses the release button, urging the locking prong away from engagement with the teeth and thereby allowing the male portion to slide within the female portion. When the desired overall length of the security device is reached so that the doors are maintained as closed and locked, the user releases the release button so that the locking prong re-engages the teeth and the T-shaped end is engaged in a gap, thus preventing the first and second locking portions from separating.

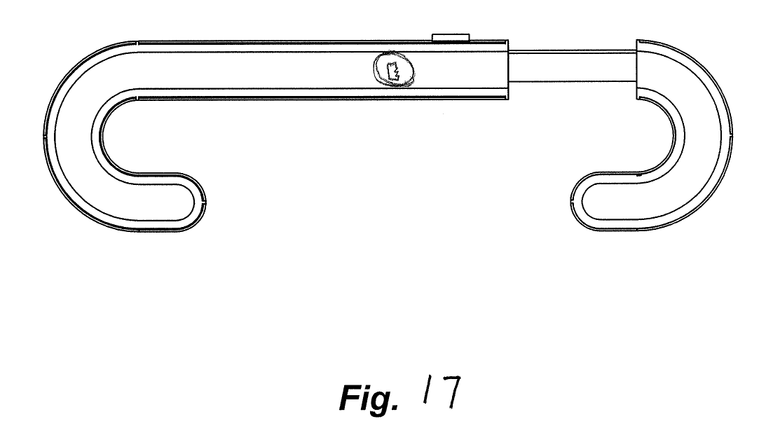

In an alternative exemplary embodiment, shown in FIG. 16, the security device can have teeth which, rather than being rectangular, can have one wall curved or angled (the leading wall, when the locking prong is slid so as to collapse the security device) so that the T-shaped end of the locking prong can flex and slide over the curved or angled teeth when collapsing the security device, even if the button is not pressed, yet the opposing, steep side (trailing) wall of the tooth would prevent movement in the other direction of the locking prong until the release button is pressed.

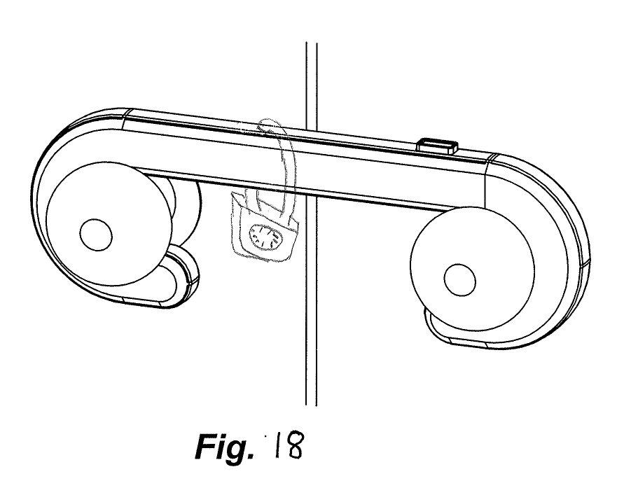

In another alternative exemplary embodiment, the door security device may have a key or combination locking mechanism incorporated in the structure, as illustrated in FIG. 17. The locking mechanism can have a cylinder with a tab that rotates when a key is inserted so that the male portion either can or cannot be slid within the female portion. In a further alternative exemplary embodiment, shown in FIG. 18, a security device may have a hole in the top and bottom (the latter not shown) of the female member and a hole in the top and bottom of the male members, all four holes aligning when the security device is in a fully locked position so that the shackle of a conventional lock.

It is to be understood that the presently disclosed security device can be used or adapted to be used with structures other than French doors, such as, but not limited to, truck or other vehicle double doors, fence doors, or other structures having at least one swinging or sliding door and two structures to which the hooks or hasps can be attached.

The present disclosure also provides a method of locking and maintaining as locked a double door, comprising providing a security device as described hereinabove, manipulating the security device as described hereinabove to separate the first and second locking portions, and engaging the first and second curved portions with doorknobs or pockets, and collapsing the first and second portions to maintain the security device in a locked configuration, thereby maintaining the double door as locked.

The present disclosure also provides an apparatus for controllably preventing or permitting access to a room or chamber, comprising providing two doors, each having a door handle, knob or pocket, as described hereinabove, and a security device as described hereinabove.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims, the singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

It should further be noted that any patents, applications and publications referred to herein are incorporated by reference in their entirety.

What is claimed is:

1. A security device for a double door, the door having a first door and a second door, each door having a set of hinges and a door handle or knob, the security device comprising:
a) a first locking member having
i) a first side having at least one first attachment post,
ii) a second side having at least one attachment aperture,
iii) at least one fastener that can pass through an attachment aperture and secure to an attachment post,
iv) a first curved portion formed by a portion of the first and second sides,
v) an elongated male portion having a top side and a bottom side, the bottom side having a first row of teeth and a second row of teeth associated therewith, there being a gap between the first and second rows of teeth forming a channel therethrough,
b) a second locking member connectable to the first locking member and having
i) a first side having at least one first attachment post,
ii) a second side having at least one attachment aperture,
iii) at least one fastener that can pass through an attachment aperture and secure to an attachment post,
iv) a second curved portion formed by a portion of the second locking member first and second sides,
v) an elongated female portion having a top side containing a slotted aperture and a channel sized to accommodate the first locking member elongated male portion,
c) a button adapted to slide within the second locking member elongated female portion slotted aperture, the button having a top first portion and an elongated post extending downward therefrom, the post terminating in a connector portion,
d) a locking prong having a base portion adapted to be connected to the second locking member and further having a finger portion including an elongated slot and a T-shaped distal end, whereby the finger portion elongated slot is sized to accept the connector portion of the post,
wherein the first locking member male portion is adapted to be received and slide within the second locking member female portion such that when the security device is in a locked configuration the locking prong can slidingly fit within the gap between the first and second rows of teeth in the elongated male portion and such that the distal end of the locking prong can fit between two adjacent teeth in neighboring rows of teeth, thereby preventing movement of the first and second locking members with respect to each other, and, when the security device is in an unlocked configuration achieved by pressing the button which causes the locking prong finger portion to flex downward and the distal end disengages from between the rows of teeth to permit sliding relative movement of the first and second locking members, thereby permitting disengagement of the security device from either or both door handles.

2. An apparatus for controllably preventing or permitting access to a room or chamber, comprising: a first door and a second door, each having a door handle, knob or pocket, as described hereinabove, and a security device according to claim 1.

3. The security device of claim 1, wherein each tooth has an angled leading edge wall and a vertical trailing edge wall.

4. A method of locking a double door having a first and a second door, each door having a door handle or pocket, comprising:
a) providing a security device according to claim 1;
b) closing the first and second doors;
c) pressing the release button to expand the security device;
d) mounting the security device on the first and second doors such that the first locking portion engages the first door handle or pocket and the second locking portion engages the second door handle or pocket;
e) pressing the release button to collapse the security device so that the first and second locking portions move toward each other; and,
f) releasing the release button to maintain the first and second locking portions in a locked relative position.
